(19) United States
(12) Patent Application Publication
(10) Pub. No.: US 2009/0080516 A1
(43) Pub. Date: Mar. 26, 2009

(54) METHOD OF ENCODING AND DECODING TEXTURE COORDINATES IN THREE-DIMENSIONAL MESH INFORMATION FOR EFFECTIVE TEXTURE MAPPING

(76) Inventors: Eun Young Chang, Jeollabuk-do (KR); Chung Hyun Ahn, Daejeon (KR); Euee Seon Jang, Seoul (KR); Mi Ja Kim, Seoul (KR); Dai Yong Kim, Seoul (KR); Sun Young Lee, Seoul (KR)

Correspondence Address: LADAS & PARRY LLP, 224 SOUTH MICHIGAN AVENUE, SUITE 1600, CHICAGO, IL, 60604, US

(21) Appl. No.: 11/719,348

(22) PCT Filed: Jan. 13, 2006
(86) PCT No.: PCT/KR2006/000151

§ 371 Date: May 15, 2007

(30) Foreign Application Priority Data
Jan. 14, 2005 (KR) 10-2005-0003832
Oct. 28, 2005 (KR) 10-2005-0102222

(51) Int. Cl. H04N 7/12

(52) U.S. Cl. 375/240.03; 375/E07.076

(57) ABSTRACT

Provided is a method of encoding and decoding texture coordinates of 3D mesh information. The method of encoding texture coordinates in 3D mesh information includes the steps of: setting an adaptive quantization step size used for quantizing the texture coordinates; quantizing the texture coordinates using the adaptive quantization step size; and encoding the quantized texture coordinates.

### TECHNICAL FIELD

The present invention relates to a method of encoding and decoding three-dimensional (“3D”) mesh information, and more particularly, texture coordinates in the 3D mesh information, which guarantees the lossless compression of them for effective texture mapping.

### BACKGROUND ART

3D graphics have been widely used, but it has a limitation to its use range due to heavy amount of information. A 3D model is expressed by the mesh information, which includes geometry information, connectivity information, and attribute information having normal, color and texture coordinates. The geometry information is comprised of three coordinate information expressed by floating points, and the connectivity information is expressed by an index list, in which three or more geometric primitives form one polygon. For example, if it is assumed that the geometry information is expressed by the floating points of 32 bits, 96 bits (i.e., 12 B) are needed to express one geometry information. That is, 120 KB bits are needed to express a 3D model having ten thousand vertices with only geometry information, and 1.2 MB are needed to express a three-dimensional model having hundred thousand vertices. The connectivity information requires much memory capacity to store the polygonal 3D mesh, since twice or more duplication is allowed.

For the reason of the huge amount of information, the necessity of compression has been raised. To this end, the 3D mesh coding (3DMC) which is adopted as a standard of International Organization for Standardization/International Electrotechnical Commission (ISO/IEC) in Moving Picture Expert Group-Synthetic and Natural Hybrid Coding (MPEG-4-SNHC) field improves transmission efficiency by encoding/decoding 3D mesh information expressed by IndexFaceSet (IFS) in a Virtual Reality Modeling Language (VRML) file.

FIG. 1 is a conceptual diagram of a typical 3DMC coding. As shown in FIG. 1, IFS data in VRML file is transformed into a 3DMC bit stream through quantization and encoding processes. The 3DMC bitstream is reconstructed by inverse quantization and decoding processes.

As the texture mapping is widely used in 3D games or interactive graphic media, a need of lossless compression for the texture coordinates in IFS is being gradually increased. However, a conventional 3DMC has a weak not to guarantee the lossless compression of the texture coordinates after decoding through the quantization process in encoding

FIG. 2 is a conceptual diagram illustrating a texture mapping error after encoding and decoding by the conventional 3DMC. FIG. 2 shows a texture mapping error occurring when an integer texture coordinate (400,800) in an original texture image is transformed into a real number between “0” and “1” in the VRML file, is subjected to encoding and decoding processes, and then is reconstructed to a different integer texture coordinate (401,801) during rendering.

As described above, the conventional 3DMC has a problem in that the integer texture coordinate of the original texture image is mapped to the real number and quantized, but is not reconstructed to the original integer texture coordinate in the reconstruction process.

### DISCLOSURE OF INVENTION

### Technical Problem

The present invention is directed to a method of encoding/decoding texture coordinates, which is capable of allowing the texture coordinate to be losslessly reconstructed for accurate texture mapping.

The present invention is also directed to a method of efficiently encoding/decoding texture coordinates by adaptively adjusting the quantization step size (or delta value) used for the texture coordinate quantization.

### Technical Solution

A first aspect of the present invention is to provide a method of encoding texture coordinates in 3D mesh information. The method comprises the steps of: determining an adaptive quantization step size used for texture coordinate quantization; quantizing the texture coordinates using the adaptive quantization step size; and encoding the quantized texture coordinates.

Preferably, the adaptive quantization step size may be determined as the inverse of the texture image size or may be determined using the texture coordinates.

The step of determining the adaptive quantization step size comprises the sub-steps of: checking whether the texture image size information exists or not; determining the inverse of the texture image size as a first quantization step size when the texture image size information exists; obtaining a second quantization step size using the texture coordinates; checking whether the second quantization step size is a multiple of the first quantization step size; determining the second quantization step size as the adaptive quantization step size when it is determined that the second quantization step size is a multiple of the first quantization step size; and determining the first quantization step size as the adaptive quantization step size when it is determined that the second quantization step size is not a multiple of the first quantization step size.

A second aspect of the present invention is to provide a method of encoding 3D mesh information. The method comprises a first encoding step for encoding a texture coordinate in the 3D mesh information according to above-described encoding method; a second encoding step for encoding remaining information of the 3D mesh information; and a step of producing 3D mesh coding (3DMC) packets which contain the 3D mesh information obtained by the first and second encoding steps and an adaptive quantization step size.

A third aspect of the present invention is to provide a method of decoding texture coordinates in 3DMC packets, which comprise the steps of: extracting adaptive quantization step size information from the 3DMC packet; inverse-quantizing the texture coordinates in the 3DMC packet using the extracted adaptive quantization step size; and decoding the inverse-quantized texture coordinates.

A fourth aspect of the present invention is to provide a 3DMC decoding method, which comprises (i) decoding texture coordinates in 3DMC packets according to above-described decoding method; (ii) decoding the remaining information of the 3DMC packets; and (iii) reconstructing a 3D model based on 3D mesh information generated from the decoding results in the steps (ii) and (iii).

### ADVANTAGEOUS EFFECTS

The method of encoding/decoding the 3D mesh information for the effective texture mapping according to the present invention achieves lossless reconstruction of the texture coordinates by adaptively adjusting the quantization step size for quantizing the texture coordinates, thereby guaranteeing the accurate texture mapping.

### BRIEF DESCRIPTION OF THE DRAWINGS

FIG. 1 is a conceptual diagram of a typical 3DMC coding;

FIG. 2 is a conceptual diagram illustrating a texture mapping error after encoding and decoding by a conventional 3DMC scheme;

FIG. 3 is a flowchart illustrating a 3DMC encoding process with texture coordinate quantization according to an embodiment of the present invention;

FIG. 4 is a flowchart illustrating the process for calculating an adaptive quantization step size (i.e., delta value) for texture coordinate quantization according to an embodiment of the present invention;

FIG. 5 is a flowchart illustrating a 3D decoding process according to an embodiment of the present invention;

FIGS. 6a to 6d show the results of quantizing texture coordinates according to the conventional 3DMC scheme and the present invention;

FIG. 7a illustrates the rendering result after the encoding/decoding is performed according to the conventional 3DMC scheme; FIG. 7b illustrates the rendering result after the encoding/decoding is performed using the inverse of the image size as the delta value according to one embodiment of the present invention; and FIG. 7c illustrates the rendering result after the encoding/decoding is performed using the delta value calculated from the texture coordinates according to another embodiment of the present invention; and

FIG. 8 shows a structure of a 3DMC packet header with a flag “delta_flag” indicating whether there is adaptive quantization step size (delta) information in a 3DMC packet according to an embodiment of the present invention.

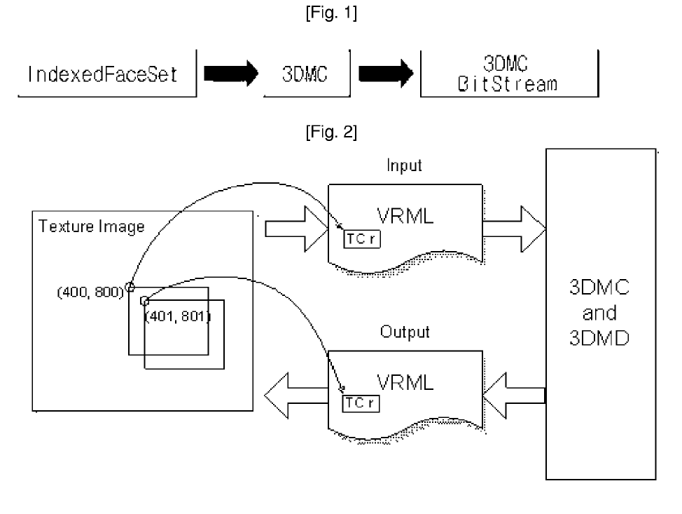

### MODE FOR THE INVENTION

The present invention will now be described more fully hereinafter with reference to the accompanying drawings, in which preferred embodiments of the invention are shown. This invention may, however, be embodied in different forms and should not be construed as limited to the embodiments set forth herein.

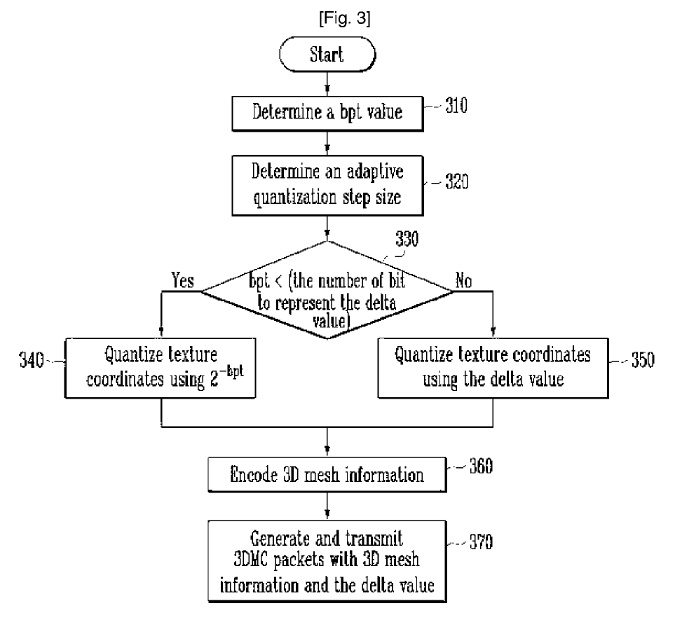

FIG. 3 is a flowchart illustrating a 3DMC encoding process with texture coordinate quantization according to an embodiment of the present invention. As shown in FIG. 3, a bpt (bits per texture coordinate) value is determined (step 310). It is well known to those skilled in the art that the determination of the bpt value is a part of a typical 3DMC coding process and is not newly proposed by the present invention. In general, the bpt value may be determined by a user, regardless of the image size.

An adaptive quantization step size is determined according to a method proposed by the present invention (step 320). The adaptive quantization step size is herein denoted by “delta”. A delta value comprises “delta_u” used for quantization of a u-axis coordinate value and “delta_v” for quantization of a v-axis coordinate value. Hereinafter, the delta value is referred to as a value containing both “delta_u” and “delta_v”.

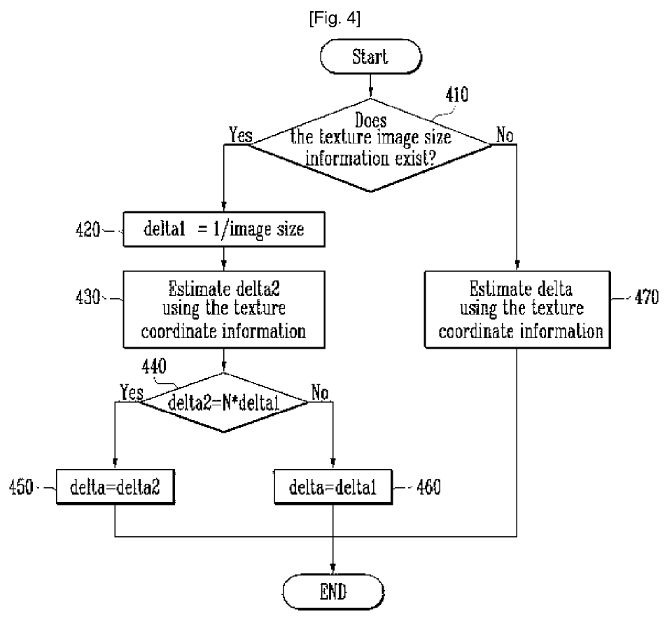

The bpt value is then compared to the number of bits to represent the delta value (step 330). If the bpt value is smaller than the number of bits to represent the delta value, the texture coordinates are quantized using the fixed quantization step size 2^{-bpt}, which is used in the conventional 3DMC process (step 340). On the other hand, if the number of bits to represent the delta value is smaller than or equal to the bpt value, the texture coordinates are quantized using the delta value (step 350). The process for obtaining the delta value according to an embodiment of the present invention will be described later with reference to FIG. 4.

3D mesh information including the quantized texture coordinates is encoded (step 360), and 3DMC packets with the delta information are generated and transmitted (step 370).

FIG. 4 is a flowchart illustrating the process for calculating the adaptive quantization step size (i.e., delta) for texture coordinate quantization according to an embodiment of the present invention.

First, it is determined whether the size information (image_size) of the texture image exists or not (step 410). When the size information of the texture image exists, the first adaptive quantization step size, delta1 (i.e., delta1_u, delta1_v) is calculated by the inverse of the image size (step 420). For example, when the image size is a*b, the delta1_u is 1/a, and delta1_v is 1/b. Alternatively, delta1_u and delta1_v may be 1/(a−1) and 1/(b−1), respectively.

Next, the second adaptive quantization step size, delta2 (i.e., delta2_u, delta2_v) is estimated using the texture coordinate values (step 430). In one embodiment, delta2 may be determined to one of the mode value, the value of greatest common divisor (GCD), the median value, the average value, the minimum value, and the maximum value of difference values between the two neighboring texture coordinate values arranged in ascending order.

It is determined whether the delta2 is a multiple of delta1 or not (step 440). When delta2 is a multiple of delta1, delta2 is determined as the adaptive quantization step size, and otherwise, delta1 is determined as the adaptive quantization step size.

Meanwhile, when it is determined that the size information of the texture image does not exist at step 410, the adaptive quantization step size (delta) is determined using the texture coordinate values (step 470). The method of estimating the adaptive quantization step size (delta) at step 470 is the same as that of estimating delta2 at step 430. The adaptive quantization step size (delta) can be determined by various other manners.

For example, when the texture image size is 800*400, since delta_u and delta_v, which are obtained according to an embodiment of the present invention, are close to divisors of 800 and 400 for u and v axes, the texture coordinate values can be reconstructed without any loss during the decoding process.

In one embodiment, in order to calculate the optimum adaptive quantization step size, the filtering is performed on the real number texture coordinates within the original VRML file. Specifically, the real number texture coordinate value is multiplied by the texture image size, round up, down or off to obtain an integer value, and then divided by the texture image size, thereby obtaining the filtered real number texture coordinate values. Table 1 shows the results of filtering on the real number texture coordinate values when the texture image size is 800*400. And also, the filtering is performed in various other manners.

TABLE 1

| Original value (float) | | Mapping value | | filtered value (float) | | Mapping value | |
|---|---|---|---|---|---|---|---|
| u | v | U | V | u | v | U | V |
| 0.688477 | 0.643555 | 550 | 257 | 0.688360 | 0.644110 | 550 | 257 |
| 0.672852 | 0.643555 | 538 | 257 | 0.673342 | 0.644110 | 538 | 257 |
| 0.911133 | 0.604492 | 728 | 241 | 0.911139 | 0.604010 | 728 | 241 |
| 0.918945 | 0.612305 | 734 | 244 | 0.918648 | 0.611529 | 734 | 244 |
| 0.958008 | 0.530273 | 765 | 212 | 0.957447 | 0.531328 | 765 | 212 |

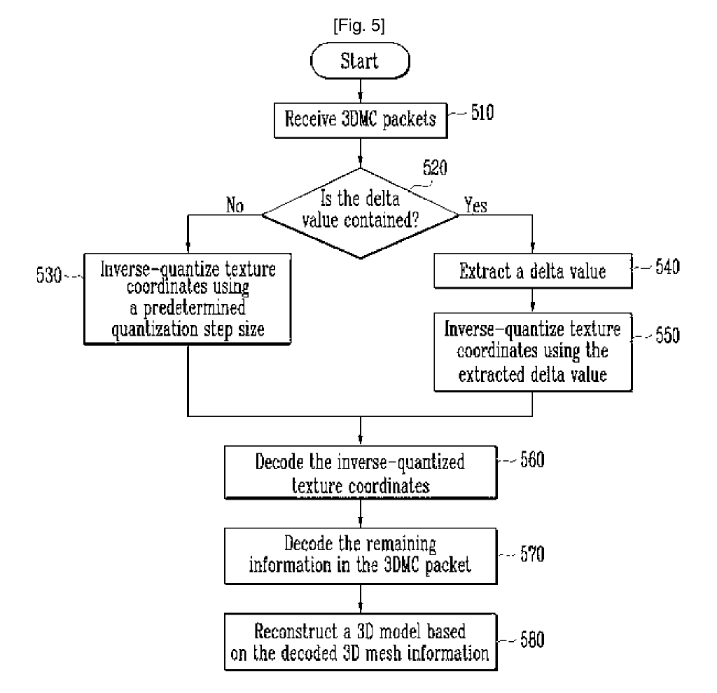

FIG. 5 is a flowchart illustrating a 3DMC decoding process according to an embodiment of the present invention. 3DMC packets are received (step 510), and it is determined whether it contains the adaptive quantization step size (delta) information or not (step 520). The determination can be performed based on a flag in the 3DMC packet header indicating whether the delta information exists.

When the delta information is not contained in the 3DMC packet, the texture coordinate values are inverse-quantized using the predetermined quantization step size, like the conventional 3DMC packet decoding process (step 530). On the other hand, when the delta information is contained in the 3DMC packet, the delta information is extracted from the 3DMC packet (step 540), and the texture coordinate values are inverse-quantized using the extracted delta information (step 550). The inverse-quantized texture coordinates are then decoded (step 560), and the remaining information within the 3DMC packets are also decoded (step 570). The 3D model may be reconstructed based on the 3D mesh information obtained at steps 560 and 570 (step 580).

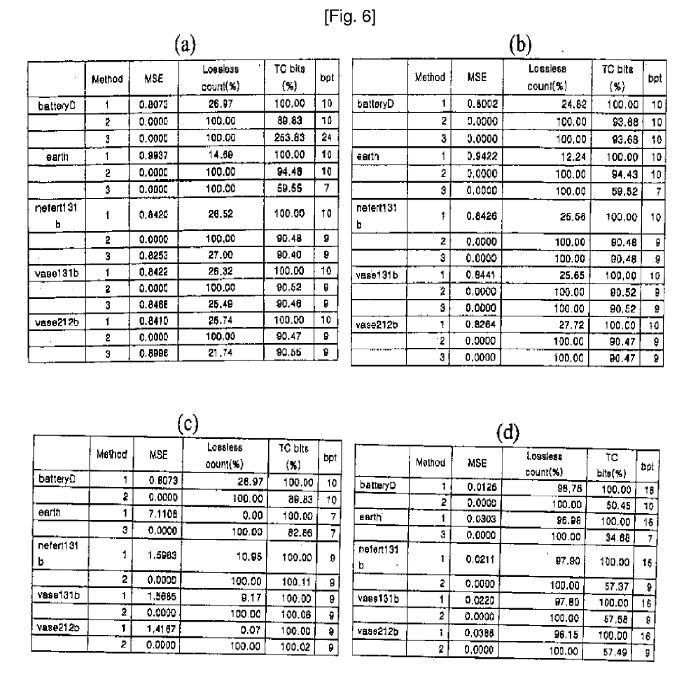

FIGS. 6a to 6d show the results of quantization of the texture coordinates according to the conventional 3DMC scheme and the present invention. The following 4 models available from a home page of MPEG-4-SNHC have been selected as test models.

TABLE 2

| Image | Image size |
|---|---|
| battery.jpg | 600*400 |
| earth.jpg | 800*400 |
| nefert131.jpg | 512*512 |
| Vase131.jpg | 512*512 |
| Vase212.jpg | mage512*512 |

The first method (“Method 1”) quantizes the texture coordinates using 2^{-bpt} as the quantization step size according to the conventional 3DMC method. The second method (“Method 2”) quantizes the texture coordinates using the first adaptive quantization step size, “delta1,” (i.e., the inverse of the image size), proposed by the present invention. The third method (“Method 3”) quantizes the texture coordinates using the second adaptive quantization step size (“delta2”).

FIG. 6a shows the encoding results of the original VRML (IFS) files of the test models using the above-described three methods. As shown, when Method 2 is used, all test models exhibit lossless compression with a bit reduction of about 10%. When Method 3 is used, the earth model exhibits lossless compression and bit reduction of about 40%.

FIG. 6b shows the encoding results of the fixed VRML (IFS) files of the test models using the above-described three methods. As shown in FIG. 6b, Method 2 and Method 3 show lossless compression that there is no error/difference value between the original file and the reconstructed file with a compression rate being 10% to 40% higher.

FIG. 6c shows the encoding results of the VRML (IFS) files of the test models according to the above-described three methods at the same bpt. As shown in FIG. 6c, the results of the present invention indicate better compression efficiency and a lower error rate.

FIG. 6d shows the comparison of the encoding results between the VRML (IFS) files of the test models according to the Method 1 at the maximum bpt “16” and that according to the Method 2 or Method using the delta1 or delta2. As shown in FIG. 6d, in all test models, the present invention shows 40% to 65% higher compression rate and lower distortion than the conventional art. Also, it is understood that the conventional art cannot achieve lossless compression even though it uses the maximum bpt.

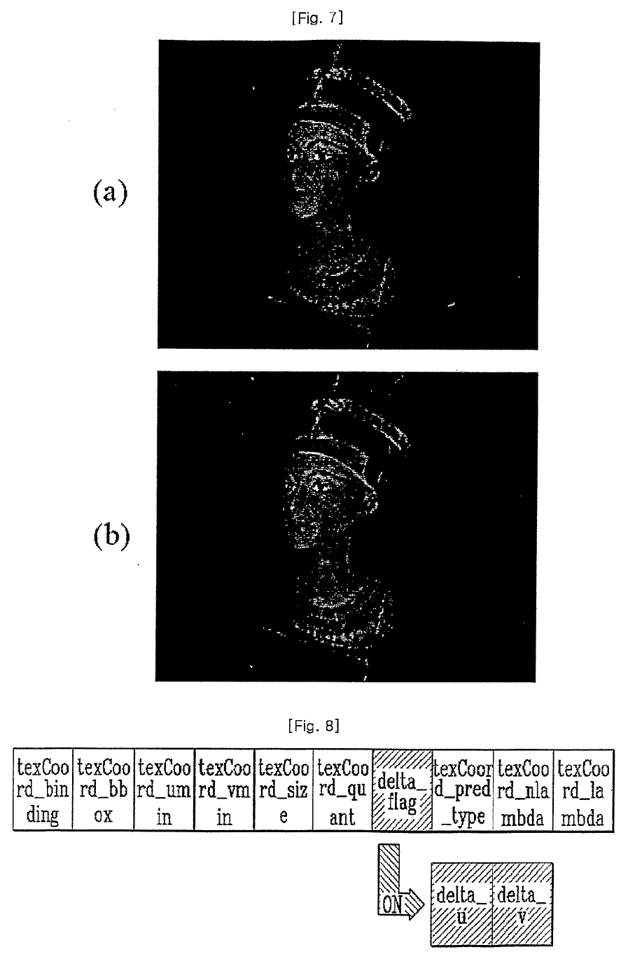

FIG. 7a illustrates the rendering result after the encoding/decoding is performed according to the conventional 3DMC scheme; FIG. 7b illustrates the rendering result after the encoding/decoding is performed using the inverse of the image size as the delta value according to an embodiment of the present invention; and FIG. 7c illustrates the rendering result after the encoding/decoding is performed using the delta value calculated from the texture coordinates according to another embodiment of the present invention.

FIG. 8 shows a structure of a 3DMC packet header with a flag “delta_flag” indicating whether there is adaptive quantization step size (delta) information in a 3DMC packet according to an embodiment of the present invention. When delta_flag is set to 1, it means that the 3DMC packet contains the delta value, i.e., delta_u and delta_v. Here, delta_u is a delta value for u-axis and delta_v is a delta value for v-axis.

The present invention can be provided in the form of at least one computer readable program which is implemented in at least one product such as a floppy disk, a hard disk, a CD ROM, a flash memory card, a PROM, a RAM, a ROM, or a magnetic tape. The computer readable program can be implemented by a general programming language.

As described above, the method of encoding/decoding the 3D mesh information for the effective texture mapping according to the present invention achieves lossless reconstruction of the texture coordinates by adaptively adjusting the quantization step size for quantizing the texture coordinates, thereby guaranteeing the accurate texture mapping.

While the invention has been shown and described with reference to certain exemplary embodiments thereof, it will be understood by those skilled in the art that various changes in form and details may be made therein without departing from the spirit and scope of the invention as defined by the appended claims.

1. A method of encoding texture coordinates in 3D mesh information, the method comprising the steps of:
determining an adaptive quantization step size used for texture coordinate quantization;
quantizing the texture coordinates using the adaptive quantization step size; and
encoding the quantized texture coordinates.

2. The method of claim 1, wherein the adaptive quantization step size is determined as the inverse of the texture image size.

3. The method of claim 1, wherein the adaptive quantization step size is determined using the texture coordinates.

4. The method of claim 3, wherein the adaptive quantization step size is determined to one of a mode value, a greatest common divisor, a median value, an average value, a minimum value, and a maximum value of difference values between the sorted texture coordinate values.

5. The method of claim 1, wherein the step of determining the adaptive quantization step size comprises the sub-steps of:
checking whether the texture image size information exists or not;
determining the inverse of the texture image size as a first quantization step size when the texture image size information exists;
obtaining a second quantization step size using the texture coordinates;
checking whether the second quantization step size is a multiple of the first quantization step size;
determining the second quantization step size as the adaptive quantization step size when it is determined that the second quantization step size is a multiple of the first quantization step size; and
determining the first quantization step size as the adaptive quantization step size when it is determined that the second quantization step size is not a multiple of the first quantization step size.

6. The method of claim 5, further comprising the step of obtaining the adaptive quantization step size using the texture coordinates when the texture image size information does not exist.

7. The method of claim 1, further comprising the steps of:
setting a bpt (bits per texture coordinate) value of the texture coordinates;
comparing the bpt value with the number of bits to represent the adaptive quantization step size;
quantizing the texture coordinates using 2^{-bpt} when the bpt value is smaller than the number of bits to represent the adaptive quantization step size; and
quantizing the texture coordinates using the adaptive quantization step size when the bpt value is greater than or equal to the number of bits to represent the adaptive quantization step size.

8. The method of claim 1, further comprising the step of filtering the real number texture coordinates using the texture image size information.

9. The method of claim 8, wherein the step of filtering the real number texture coordinates comprises the sub-steps of: for each real number texture coordinate value,
multiplying the real number texture coordinate value by the texture image size and round up, down or off the resultant value to obtain a corresponding integer texture coordinate; and
replacing the real number texture coordinate with a value obtained by dividing the corresponding integer texture coordinate by the texture image size.

10. The method of claim 8, wherein the step of filtering the real number texture coordinate comprises the sub-steps of:
multiplying the real number texture coordinate value by (the texture image size minus 1) and round up, down or off the resultant value to obtain a corresponding integer texture coordinate; and
replacing the real number texture coordinate with a value obtained by dividing the corresponding integer texture coordinate by (the texture image size minus 1).

11. A method of encoding 3D mesh information, the method comprising:
a first encoding step for encoding texture coordinates in the 3D mesh information according to any one of claims 1 to 10;
a second encoding step for encoding remaining information of the 3D mesh information; and
a step of producing 3D mesh coding (3DMC) packets which contain the 3D mesh information obtained by the first and second encoding steps and an adaptive quantization step size.

12. A method of decoding texture coordinates in 3DMC packets, the method comprising the steps of:
extracting adaptive quantization step size information from the 3DMC packet;
inverse-quantizing the texture coordinates in the 3DMC packet using the extracted adaptive quantization step size; and
decoding the inverse-quantized texture coordinates.

13. The method of claim 12, further comprising the step of determining whether the adaptive quantization step size information is contained in the 3DMC packet, wherein the texture coordinates are quantized using a predetermined quantization step size when it is determined that the adaptive quantization step size information is not contained in the 3DMC packet.

14. The method of claim 13, wherein the step of determining whether the adaptive quantization step size is contained in the 3DMC packet uses a flag in a header of the 3DMC packet, the flag indicating whether the adaptive quantization step size is used or not.

15. A 3DMC decoding method, comprising the steps of:
(i) decoding texture coordinates in 3DMC packets according to any one of claims 12 to 14;
(ii) decoding the remaining information of the 3DMC packets; and
(iii) reconstructing a 3D model based on 3D mesh information generated from the decoding results in the steps (ii) and (iii).

16. A computer readable recording medium containing a computer program which performs the method of encoding texture coordinates in 3D mesh information according to any one of claims 1 to 10.

17. A computer readable recording medium containing a computer program which performs the method of decoding texture coordinates in a 3DMC packet according to any one of claims 12 to 14.
